(19) United States
(12) Patent Application Publication
(10) Pub. No.: US 2020/0183504 A1
(43) Pub. Date: Jun. 11, 2020

(54) INPUT ELEMENT FOR A TOUCH-SENSITIVE SCREEN

(71) Applicant: Interactive Scape GmbH, Berlin (DE)

(72) Inventors: Hauke Helmer, Berlin (DE); Günter Paul Peters, Berlin (DE); Denny Kruse, Berlin (DE); Philipp Ewerling, Berlin (DE); Ulrich Mangold, Berlin (DE)

(21) Appl. No.: 16/311,655

(22) PCT Filed: Jan. 22, 2018
(86) PCT No.: PCT/EP2018/051487

§ 371 Date: Aug. 6, 2019

(30) Foreign Application Priority Data
Jan. 23, 2017 (DE) 10 2017 201 042.8

(51) Int. Cl. G06F 3/039; G06F 3/038; G06F 3/0362; G06F 3/041

(52) U.S. Cl. CPC G06F 3/0393; G06F 3/0416; G06F 3/0362; G06F 3/0383

(57) ABSTRACT

The invention relates to an input element (1) for a touch-sensitive screen (20), comprising
a first communication unit (4) for communicating with a control and processing unit (30);
at least two touch surfaces (5) which are detectable by the touch-sensitive screen (20); and
an acceleration sensor (10) for detecting an acceleration of the input element (1).

The invention further relates to a method as well as a computer program for recognising an input element on a touch-sensitive screen.

The invention relates to an input element for a touch-sensitive screen, according to the main claim, as well as to a method for recognising an input element on a touch-sensitive screen, according to the further independent claim.

Nowadays, touch-sensitive screens (touchscreens) are used in different fields. Touch-sensitive screens are used for example in smartphones, tablet PCs and in a large variety of vending machines. One advantage of these touch-sensitive screens is the fact that an input as well as an output can be effected via the screen. Touch-sensitive screens are typically capable of detecting the location of the screen at which it was touched by a finger.

Capacitive touch screens are applied in many touch-sensitive screens. Here, two grids of transparent electrical conductors which are aligned transversely to one another lie in a glass. The upper of the two conduction grids constantly sends electrical signals to the lower grid. If the screen is touched by a finger, then an electrical capacitance of the insulating layer which lies therebetween changes and a signal at these locations becomes weaker. A processor then computes a position at which the signal has dropped off, and transfers the location and the duration of the touch to software of the device. The latter then executes a corresponding action as a response to the touch.

Such capacitive touch-sensitive screens which moreover can often simultaneously detect a multitude of touches (multitouch displays) are not usually designed to detect passive objects which are placed upon the touch-sensitive screen. On the contrary; such systems typically comprise filters in order to filter out touch data which is triggered by passive objects.

Various passive input elements which are detectable by a touch-sensitive screen have been suggested in literature. Here, e.g. in the case of capacitive touch-sensitive screens, there is the limitation that a user himself must touch these input elements in order for the touch-sensitive screen to be capable of detecting these input elements. This leads to various problems. On the one hand, the system cannot reliably differentiate whether an object has been removed from the screen or whether a user has stopped touching the object. A movement of an input element is not detectable by the system if the input elements is moved without being touched.

Examples of such input elements are described in the subsequent publications: “PUCs: Detecting Transparent, Passive Untouched Capacitive Widgets on Unmodified Multi-touch Displays, Simon Voelker, Kosuke Nakajima, Christian Thoresen, Yuichi Itoh, Kjell Ivar Øvergård, and Jan Borchers, ITS '13: Proceedings of the ACM International Conference on Interactive Tabletops and Surfaces, pages 101-104, New York, N.Y., USA. 2013” and “PERCs: Persistently Trackable Tangibles on Capacitive Multi-Touch Displays, Simon Voelker, Christian Cherek, Jan Thar, Thorsten Karrer, Christian Thoresen, Kjell Ivar Øvergård, and Jan Borchers, UIST '15: Proceedings of the 28th Annual ACM Symposium on User Interface Software and Technology, UIST '15, pages 351-356, New York, N.Y., USA. November 2015”.

Input elements for a touch-sensitive screen should fulfil at least one or two or more of the following conditions for a trouble-free operation:
1. The system should be able to determine at all times whether or not input units are currently present on the touch-sensitive screen and specifically independently of whether they are being touched by the user or not.
2. Each input unit should be unambiguously identifiable.
3. The system should be capable of detecting an exact position and/or orientation of the input element or of the input elements.
4. A change of the position and orientation of rapidly moving input elements should be detectable without a noticeable delay.

It has been found that many input elements which are disclosed in the state of the art are not capable of fulfilling at least one or more than one or all of these four conditions or not to a satisfactory extent.

It is the object of the invention to put forward an input element for a touch-sensitive screen, said input element overcoming the disadvantages of the state of the art. Furthermore, it is the object of the invention to provide a method for recognising an input element on a touch-sensitive screen, said method capable of overcoming the disadvantages of the state of the art.

The object is achieved by an input element according to the main claim as well as by a method according to the further independent claim. Further developments result from the features of the dependent claims as well as from the subsequent description.

The input element for a touch-sensitive screen comprises a first communication unit for communicating with a control and processing unit. The input element further comprises at least two touch surfaces which are detectable by the touch-sensitive screen. The input element furthermore comprises an acceleration sensor for detecting an acceleration of the input element.

At least one or two or more of the aforementioned four conditions can be fulfilled with the suggested input element.

A speed increase and/or a speed reduction of the input element in different directions can be recognised with the help of the acceleration sensor. The direction in which the input unit is accelerated can be detected for example by the acceleration sensor by way of the acceleration sensor determining from where the gravity acts upon the input element. Hereby, a measurement of the acceleration is generally effected in three spatial directions, which are perpendicular to one another.

In a further development, the acceleration sensor is designed for detecting a putting-down of the input element onto the touch-sensitive screen. The input element typically obtains a characteristic acceleration by way of the putting-down of the input element onto the touch-sensitive screen. One can therefore recognise whether the input element has been placed on the touch-sensitive screen by way of detection of this characteristic acceleration.

The acceleration sensor can further be designed for detecting a picking-up of the input element from the touch-sensitive screen. The input element also obtains a characteristic acceleration on picking up the input element, said acceleration being detectable by the acceleration sensor. One can therefore ascertain that the input element has been removed from the touch-sensitive screen by way of measuring this characteristics acceleration.

Furthermore, the acceleration sensor can be designed for detecting an acceleration of the input element on the touch-sensitive screen. This means that if the input element is moved on the touch-sensitive screen after having been put down onto the touch-sensitive screen, then this is detectable by the acceleration sensor. If for example two or more than two input elements are located on the touch-sensitive screen and one or more of these are moved or rotated, then one can ascertain which of the input elements has just been moved, since the acceleration sensor is capable of detecting accelerations in a very accurate manner. The signals which are measured by the acceleration sensor can therefore also be used for the identification of the input element.

An accuracy of the acceleration sensor can be at least ±2.5% of 8 g, 4 g or 2 g or smaller, that is ±0.2 g, ±0.1 g or ±0.05 g or smaller, wherein g is the locally dependent acceleration of gravity and is e.g. approx. 9.81 m/s².

If only two touch surfaces are provided or e.g temporarily only two touch surfaces are detected by the touch-sensitive screen, then under certain circumstances this can lead to an ambiguity with regard to a rotation or a rotation angle of the input element. Two touch surfaces of the same type indeed trigger the same signal in the touch-sensitive screen given a rotation of the input element by 180°. If the input element is now moved, then the rotation or the rotation angle (orientation) of the input element can be unambiguously resolved by way of the measured, directional acceleration as well as the movement of the touch surfaces on the touch-sensitive screen.

Furthermore, by way of a temporal resolution of the acceleration, one can determine when and which input element has been placed onto the touch-sensitive screen. This is advantageous given a quasi-simultaneous placing-on of different input units, since one can hence unambiguously determine which input element has been placed where and when. For this, the acceleration sensor can be designed for detecting an acceleration with a temporal accuracy of at least 100 milliseconds, preferably at least 50 milliseconds, particular preferably at least 20 milliseconds, in particular at least 10 milliseconds. A data transmission rate of the acceleration sensor can be between 1.6 Hz and 800 Hz, i.e. values can be transmitted every 641 ms or every 1.25 ms. In a similar manner, the touch-sensitive screen can have a temporal resolution of at least 100 milliseconds, preferably at least 50 milliseconds, particular preferably at least 20 milliseconds, in particular at least 10 milliseconds, for a detection of a touch. Preferably, time measurements are synchronised in the input unit and in the touch-sensitive screen, so that temporal sequences can be compared to one another.

The first communication unit is preferably designed as a wireless communication unit. Given a wireless design, the first communication unit comprises at least one sending unit for sending radio signals. Optionally, a receiving unit can be additionally provided for receiving radio signals. The first communication unit further comprises e.g. an antenna for sending and/or receiving radio signals. The first communication unit can form part of a network. Possible wireless connections include for example WLAN or WPAN, in particular Bluetooth or other near-field connections. The first communication unit transfers the data and/or signals of the sensors to a second communication unit typically in intervals of 10 ms to 20 ms (see below).

One can further envisage the input unit being designed for creating a connection to the control and processing unit by way of the first communication unit if an acceleration which differs from the gravitational acceleration and/or a change of the acceleration is detected by the acceleration sensor. Electricity can be saved (energy saving mode) by way of the connection of the first communication unit to the second communication unit only being created and/or maintained if an acceleration which differs from the gravitational acceleration and/or a change of the acceleration is ascertained.

The touch-sensitive screen can comprise optical, capacitive, inductive or resistive sensors or a combination of two or more of these sensors for the measurement of touches on the touch-sensitive screen. These are known from the state of the art by the person skilled in the art. In particular, the touch-sensitive screen is designed to simultaneously detect a multitude of touch surfaces (multitouch display).

As described further above, a capacitive touch-sensitive screen usually comprises two grids of transparent electrical conductors which are aligned transversely to one another. If the screen is touched by a certain touch surface of an input element or by a finger of the user, then the mutual electrical capacitance of the crossing electrical conductors of the touch-sensitive screen changes at the location of contact and the signal becomes weaker at these locations. This however presupposes a coupling of the contact surface to earth. The coupling can hereby be effected e.g. via the body of a user. However, since, with the exception of a horizontal and a vertical detection strip conductor of the mentioned grid, e.g. adjacent detection strip conductors lie at earth, a discharge is also possible if a second touch surface is provided and is located on the detection strip conductor which lies at earth. As a rule therefore, the touch surfaces of the input element are connected to one another in an electrically conductive manner in order to permit the described coupling or the discharge of the electrical capacitance. Due to the provision of at least two touch surfaces which are electrically conductively connected to one another, it is no longer necessary for the input element to be touched by a user for a reliable detection by the touch-sensitive screen. With the input element resting on the touch-sensitive screen, the conductive connection between the touch surfaces is typically distanced to the touch-sensitive screen. The conductive connection between the touch surfaces herein as a rule is arranged such that the conductive connection has a distance of at least 1 mm or at least 2 mm to the touch-sensitive screen. The mentioned conductive connection can be realised by one or more metal strips or metal wires, e.g. of copper and/or aluminium, which connect the contact surfaces to one another. The following publication which by way of reference is incorporated in its entirety into this disclosure is referred to for further details:

“PUCs: Detecting Transparent, Passive Untouched Capacitive Widgets on Unmodified Multi-touch Displays. Simon Voelker, Kosuke Nakajima. Christian Thoresen, Yuichi Itoh. Kjell Ivar Øvergård and Jan Borchers, ITS '13: Proceedings of the ACM International Conference on Interactive Tabletops and Surfaces, pages 101-104, New York, N.Y., USA, 2013”

Under certain circumstances, it can occur that both contact surfaces are arranged on the touch-sensitive screen in a manner such that a coupling to earth is not possible. For example, both touch surfaces are located on the same detection strip conductor. For this reason, it can be advantageous if at least three or at least four or at least five or even more touch surfaces are provided. Specifically, the probability of the coupling of the touch surfaces to a detection strip conductor which lies at earth becomes greater and greater by way of this.

An arrangement of the touch surfaces on the input element can be termed as a touch pattern. Herein, the touch pattern is usually also two-dimensional in accordance with a two-dimensional surface of a touch-sensitive screen. As a rule, the touch surfaces of the touch pattern therefore lie in a plane. If three or more touch surfaces are provided, it is advantageous for these to be arranged in a manner such that the respective touch pattern at the most has a C₅-symmetry or a C₁-symmetry. In other words, the touch pattern cannot have a rotational symmetry. An unambiguity of the detected touch pattern can be reduced in this case. As described above, the touch-sensitive screen as a rule comprises two grids of transparent strip conductors. Here, the strip conductors of the grids cross at a crossing angle. The probability of a coupling via a strip conductor which lies at earth is greater if the crossing angle of the strip conductors of the touch-sensitive screen is avoided in the touch pattern. For example, three of the touch surfaces are indicated as A. B and C. Two straight lines are formed by the connection paths A-B and B-C. An angle α which is enclosed by the connection paths A-B and B-C is preferably 0°<α<90° or 90°<α<180° if the crossing angle of the strip conductors of the touch-sensitive screen is 90°. In particular, α is therefore not equal to 0°, 90°, or 180°. Given a crossing angle ß of the strip conductors, the angle α which is enclosed by the connection paths is preferably not equal to 1 and/or not equal to 180°−ß and/or either 0°<α<ß or ß<α<180°−ß or 180°−ß<α<180° applies. Furthermore, the connection paths A-B, B-C, and A-C can each have a length which differs from the lengths of the other two connection paths. The mentioned conditions for the angles and the lengths of the connection paths can be fulfilled for random combinations A, B and C of all touch surfaces. A length of the connection path between the centres of gravity of two touch surfaces can be e.g. at least 20 mm, at least 22 mm, at least 24 mm or at least 26 mm.

The touch surfaces can comprise for example a material which changes an electrical field in a manner similar to a finger of a human. A suitable material for the contact surfaces would be e.g. conductive rubber. Here, rubber can further prevent scratches being made on a surface of the touch-sensitive screen. The touch surfaces, in particular friction characteristics of an applied material of the touch surfaces, should be designed such that a rotation of the input object on the touch-sensitive screen, initiated by a hand of the user, is possible.

Furthermore, it is advantageous if the touch surfaces have a shape which is similar to the shape of a fingertip on touching the touch-sensitive screen, since the touch-sensitive screens as a rule are designed to detect touches of a fingertip. The touch surfaces are typically round or elliptical or oval. The touch surfaces can further have a diameter of at least 11 mm, preferably at least 12 mm or at least 13 mm, so that they can be reliably detected by the touch-sensitive screen. The touch surfaces can further comprise a diameter of at the most 15 mm, preferably at the most 14 mm or at the most 13 mm.

In an embodiment, the input element comprises a gyroscope for detecting a rotational movement of the input element. The gyroscope measures e.g. a rotational speed and therefore rotary movement of the input element. The gyroscope typically uses Coriolis force and the so-called tuning fork principle for determining the orientation. In the gyroscope, which typically has a size of 4×4 mm, e.g metal elements are brought into oscillation by way of a current. If the input unit moves, then the oscillation of the metal elements changes and capacitors which are arranged around this register a change which is then detected as a rotation movement. Other rotation speed sensors which correspond to the state of the art are conceivable. The gyroscope can preferably detect rotation speeds of up to 2000°/s with an accuracy of 0.0625°/s and with a data rate e.g. of 12.5 Hz to 800 Hz.

In a further development, the input element unit comprises a field sensor for detecting an electrical field strength of the touch-sensitive screen and/or for measuring a change of the electric field strength of the touch-sensitive screen. By way of the field sensor, one can therefore also detect whether the input element is resting on the touch-sensitive screen. The field sensor can be designed to detect an electrical field strength in at least one of the touch surfaces. If the field sensor is designed to detect an electrical field strength in at least one of the touch surfaces, then this respective touch surface serves as an antenna for the field sensor. The field sensor can detect the field strength e.g. with a measuring frequency of at least 50 kHz, at least 100 kHz, at least 200 kHz or at least 300 kHz. For example, the field sensor detects the field strength with a frequency of 400 kHz.

In a further embodiment, the input element comprises a colour sensor or several colour sensors for detecting a colour in at least one region of the touch-sensitive screen, said colour being displayed by the touch-sensitive screen. In particular, the colour sensor is designed as a light sensor which detects at least a part of the visible spectrum (thus roughly from 380 nm to about 780 nm). The colour sensor can also be designed as a camera. For example, a position change of the input element can be detected by way of a detection of a certain colour on the touch-sensitive screen and a comparison of this colour with a colour course or colour pattern, said course or pattern being reproduced by the touch-sensitive screen. If only one or no touch surface is temporarily recognised by the touch-sensitive screen, then a second colour sensor can be used in order to determine an initial position and initial rotation angle of the input element. For this, the touch-sensitive screen displays a colour pattern or a colour course. The control and processing unit (see below) can then determine, with the help of the colour which is recognised by the colour sensor, which of the touch surfaces has been recognised by the touch-sensitive screen and where the colour sensors are located on the screen. The current position and orientation of the input element can then be determined from the positions of the two colour sensors and of the touch surface.

In a further embodiment, the input element comprises a proximity sensor for detecting a distance between the touch-sensitive screen and the input element. A range of the proximity sensor can be up to 10 cm depending on the embodiment. The proximity sensor usually uses an infrared beam in order to examine whether the screen is approaching the input unit. If, for example, the input unit is placed onto the touch-sensitive screen, then the proximity sensor registers a reflection of the infrared beams by the screen, by which means it is detected that the input unit is located on the touch-sensitive screen.

Furthermore, the input element can comprise a memory, such as e.g. a random access memory (RAM), read only memory (ROM), a hard disc, a magnetic memory medium and/or an optical drive. An identification code or an identification number, e.g. a UUID, which is assigned to the input element, can be stored in the memory. The identification code or the identification number can be unique for each of these input elements given a multitude of input elements, i.e. different input elements have different identification codes or identification numbers. After a connection has been built up between the first communication unit and the second communication unit, the identification code or the identification number can be transferred to the control and processing unit. Sensor data and/or sensor signals can be linked to the identification code and/or to the identification number of the respective input element.

Moreover, a program, e.g. software for processing or handling the data and/or the signals of a sensor or of several of the aforementioned sensors can be stored in the memory.

The input unit can comprise a processor, a microcontroller, a microprocessor and/or a digital signal processor which is designed
to process, to handle and/or to evaluate signals of the aforedescribed sensors (acceleration sensor and/or gyrocope and/or colour sensor and/or proximity sensor); and/or
to activate one or more or all of the described sensors.

Usually, the input element comprises a housing in which the first communication unit and the acceleration sensor and, if present, additional aforedescribed sensors are arranged. The housing can be designed e.g. in an essentially rotationally symmetrical, annular, rhomboidal, cube-shaped, disc-shaped, cylinder-shaped manner or be designed as a plate. A diameter of the housing can be at least 5 cm, at least 6 cm or at least 7 cm. Furthermore, a height of the housing can be at least 0.5 cm or at least 2 cm or at least 5 cm and/or at the most 10 cm or at the most 8 cm or at the most 6 cm. Furthermore, a battery or an accumulator for the electricity supply of the sensors and of the first communication unit can be provided in the housing. The housing can be manufactured of moulded rubber, wherein the rubber preferably has a Shore hardness of A80. Furthermore, the housing can also have an outer skin of the mentioned moulded rubber with the Shore hardness of A80.

The touch surfaces are arranged for example on a lower side of the housing. The lower side of the housing is hereby usually designed such that it can be placed onto the touch-sensitive screen. The lower side of the housing can be protected by a non-conductive protective film which at the most is 0.05 mm thick, preferably at the most 0.1 mm, in particular at the most 0.2 mm thick and which is also capable of improving the sliding characteristics of the input element. A base area of the lower side of the input element can be for example at least 5 cm², at least 10 cm², at least 15 cm², at least 20 cm² or at least 25 cm² depending on the embodiment. More or fewer touch surfaces can be present depending on the dimensions of the base area. If a coupling to the body of a user (see above) is possible at least when placing the input element onto the touch-sensitive screen, then e.g a relatively small touch pattern of three touch surfaces can be provided on a base area of about 25 cm². If a coupling to the body of the user is not possible on placing the input element onto the touch sensitive screen, then a larger touch pattern of at least four touch surfaces can be provided on a base area of about 50 cm² or larger.

The touch surfaces can be materially, positively or non-positively connected to the housing. The touch surfaces can also be designed as stickers and be stuck onto the housing of the input element. The touch surfaces can also be arranged on a cover or sleeve which is fastened to the input element or is releasably connected to the input element. The cover or sleeve can comprise e.g. rubber, such as silicone rubber, polybutadiene rubber or vulcanised natural rubber or consist of one of the mentioned materials.

An electrically conductive coupling element can be provided on the housing in order to improve the electrical coupling to earth via the body of the user, wherein the coupling element is electrically connected to the touch surfaces, for example via metal wires or metal strips. The coupling element is preferably arranged on the housing of the input element in a manner such that a user grips the coupling element on putting down the housing onto the touch-sensitive screen. The coupling element is arranged for example on an upper side of the housing. The coupling element can comprise e.g. a metal or be formed of a metal and/or be designed as a strip or a ring. The coupling element preferably has a distance of at least 1 mm, at least 2 mm, at least 3 mm or more to the lower side of the housing. Disturbances in the touch-sensitive screen, which are caused by the electrically conductive coupling element, are avoided by way of this. The coupling element can be provided with a very thin insulating layer of at least 0.05 mm, so that the material does not feel “cold” and/or for the optical amelioration. The insulation layer should hereby not be thicker than 2 mm in order to ensure an adequate coupling to earth through the insulating layer. The insulating layer can e.g. be varnish or a film.

In particular, the input element can be designed as a smartphone or even as a tablet PC. The touch surfaces can then be connected to the smartphone or tablet PC as stickers or via the sleeve or cover. Nowadays many smartphones or tablet PCs already have an acceleration sensor and/or a camera and/or a gyroscope and/or a proximity sensor and/or a communication unit and/or an identification code/identification number and/or a memory and/or a processor, so that an existing system can be provided with touch surfaces and corresponding software at a later stage and be upgraded into a previously described input element for a touch-sensitive screen.

Furthermore, a multitude of input elements can be provided. The touch surfaces of each input element typically form a touch pattern, wherein each input element typically comprises an equal touch pattern. Furthermore, each input element can comprise a memory in which an identification code or an identification number is stored, said code or number being assigned to the respective input element. An unambiguous identification of each individual input element is rendered possible by way of this.

The aforementioned sensors can have a transmission rate of between 1.6 Hz and 800 Hz. i.e. measured signals of the sensors can be transmitted to the first communication unit every 641 ms and every 1.25 ms respectively.

Furthermore, a control and processing unit is provided by the invention.

The control and processing unit can be designed to process or handle signals or data of an aforementioned sensor or several of the aforementioned sensors. In order to process and/or handle the signals and/or the data of the aforementioned sensors, the control and processing unit can comprise a microcontroller, a processor, a microprocessor and/or a digital signal processor for. Here, a digital signal processor (DSP) can be designed for a continuous processing of digital signals, for example digital signals of the aforementioned sensors. One can further envisage the control and processing unit being designed to activate one or more of the mentioned sensors.

Furthermore, the control and processing unit can comprise one or more memories, such as e.g random access memory (RAM), read only memory (ROM), a hard disc, a magnetic memory medium and/or an optical drive. A program, e.g. software for processing or handling the data and/or the signals of a sensor or several of the aforementioned sensors can be stored in the memory.

The control and processing unit comprises a second communication unit for communicating with the aforementioned input element or with a multitude of input elements. The second communication unit is preferably designed as a wireless communication unit. Given a wireless design, the second communication unit comprises at least one receiving unit for receiving radio signals. Optionally, a sending unit for sending radio signals can be provided. Furthermore, the second communication unit comprises e.g. an antenna for sending and/or receiving radio signals. The second communication unit can form a part of a network or be connected to a network Possible wireless connections include for example WLAN or WPAN, in particular Bluetooth, or other near-field connections.

The first communication unit of the input element and the second communication unit of the control and processing unit can be connected to one another in particular in a wireless manner, for example via WLAN or WPAN, in particular via a Bluetooth connection or another near-field connection. Other types of wireless connections between the first communication unit and the second communication unit, such as EnOcean, Z-Wave, ZigBee, WiMAX, UMTS/HSDPA, LTE (long term evolution), NanoNetm, UWB (Ultra Wideband) are likewise possible and are known to the person skilled in the art.

The control and processing unit can be designed for receiving and/or evaluating a signal which is detected by the acceleration sensor of the input element. The control and processing unit can further be designed for recognising, on the basis of the signals of the acceleration sensor, a putting-down of the input element onto the touch-sensitive screen and/or a movement direction and/or a placing of the input element on the touch-sensitive screen and/or a picking-up of the input element from the touch-sensitive screen. Alternatively or additionally, the evaluation of the signals which are detected by the acceleration sensor and/or the recognition on the basis of the signals of the acceleration sensor can also be effected in the input element.

In a further development, the control and processing unit is connected to the touch-sensitive screen. Furthermore, it can be designed for receiving and/or evaluating signals (touch signals) which are triggered in the touch-sensitive screen by the touch surfaces of the input element. The control and processing unit can be designed to compare the touch signals with the sensor data/sensor signals, and, on the basis of the comparison, to determine a position and/or orientation of the input element on the touch-sensitive screen.

For example, the control and processing unit can be designed for recognising a position and/or orientation of the input element on the touch-sensitive screen on the basis of the signals of the acceleration sensor and of the signals which are triggered by the touch surfaces of the input element in the touch-sensitive screen.

The connection of the control and processing unit to the touch-sensitive screen can likewise be in a wireless manner; however it can also be a connection by way of a cable, for example a USB cable.

One can envisage the control and processing unit and the touch-sensitive screen being arranged in a single housing. A particularly compact system can be provided by way of this. For example, the touch-sensitive screen and the control and processing unit can be designed as a tablet computer or smartphone.

One can envisage the control and processing unit being designed for determining a variance of the electrical field strength which is temporally measured by the field sensor of the input element. The variance of the signal can be computed e.g via a multitude of different values. Conceivable here in particular are more than 100 values, more than 1000 values or more than 2000 values, in particular 4000 values.

Typically, the determined variance of the electric field is compared with a predefined value. If the determined variance is larger than the predefined value, then one can detect that the input element is arranged on the touch-sensitive screen. The determined variance of the electrical field strength on capacitive touch-sensitive screens is more than a thousand-fold that of a measured variance without a screen and given a distance of 5 mm between the input element and the touch-sensitive screen is roughly a hundred-fold. This allows, without calibration to a special touch-sensitive screen, the detection of whether the input element is resting on the touch-sensitive screen.

In a further development, the control and processing unit is designed for evaluating signals of the gyroscope of the input element. Furthermore, the control and processing unit is designed to determine a rotation angle of the input element on the basis of the measured signals.

In a further development, the control and processing unit is designed for evaluating and/or receiving signals which are triggered in the touch-sensitive screen by the touch surfaces of the input element; determining an orientation of the touch surfaces on the touch-sensitive screen on the basis of the signals which are triggered in the touch-sensitive screen by the touch surfaces of the input element; and calibrating the gyroscope for determining an absolute rotation angle of the input element with respect to a fixed coordinate system of the touch-sensitive screen. Herewith, an initial orientation of the input element on the touch-sensitive screen can be detected via the touch surfaces, and one can subsequently determine the orientation of the input element on the touch-sensitive screen to a high precision on the basis of this detected orientation and the signals which are measured by the gyroscope.

In a further development, the control and processing unit is designed for receiving and/or evaluating a signal which is measured by the colour sensor or colour sensors of the input element: for comparing the signal with a colour signal of the touch-sensitive screen; and for determining a position and/or a rotation angle of the input element on the basis of the comparison. For example, certain colours or a certain colour pattern are displayed on the screen, wherein the displayed colours are measured by the colour sensor and again are forwarded to the control and processing unit. Thus by way of comparison of the colours which are measured by the colour sensor and of the colour signals which are outputted by the touch-sensitive screen, one can ascertain where the input element is located on the screen at this moment and/or what the rotation angle of the input element momentarily is.

The control and processing unit can moreover be designed to activate the touch-sensitive screen or other devices or to carry out a certain action, depending on a position and/or a rotation angle and/or a position change and/or a rotation angle change of the input element.

Furthermore, a method for recognising an input element on a touch-sensitive screen is provided by the invention, wherein the input element comprises at least two touch surfaces which are detectable by the touch-sensitive screen.

The method comprises the following steps: detecting an acceleration of the input element by way of an acceleration sensor; evaluating a signal which is detected by the acceleration sensor: and recognising, on the basis of a measured acceleration, a putting-down of the input element onto the touch-sensitive screen and/or a movement direction and/or a resting of the input element on the touch-sensitive screen and/or a picking-up of the input element from the touch-sensitive screen.

The method can further comprise the following steps:
building up a radio connection between the first communication unit of the input element and the second communication unit of the control and processing unit;
determining an identity of the input element by way of transferring the identification code or the identification number, which is stored in the memory of the input element, to the control and processing unit.

The method can comprise the following steps:
recognising a position and/or orientation of the input element on the touch-sensitive screen if it is simultaneously detected by the touch-sensitive screen as well as by the further sensors, that the input element is put down onto the touch-sensitive screen and/or the input element is located on the touch-sensitive screen.

The simultaneous detection hereby includes a temporal difference of at the most 50 ms or at the most 30 ms or at the most 20 ms between the detections.

In particular, the method can comprise one or more steps which have been described above on explaining the input element and/or the control and processing unit. The method can be implemented e.g. as a code, for example in the form of a computer program on a computer-readable medium, such as a volatile memory or a non-volatile memory.

Furthermore, the invention relates to a non-volatile memory which is readable by a computer. The non-volatile memory comprises a computer program which, when it is runs on a programmable hardware component, is designed for
evaluating a signal which is detected by an aforedescribed acceleration sensor of a previously described input element;
recognising, on basis of the measured acceleration
   a putting-down of the input element onto the touch-sensitive screen and/or
   a movement direction and/or a resting of the input element on the touch-sensitive screen and/or
   a picking-up of the input element from the touch-sensitive screen.

The computer program can be stored in the memory of the input element and/or in the memory of the control and processing unit. The computer program can be carried out by a programmable hardware component, such as e.g. a processor, a CPU, a GPU or a multi-processor system. Here, the programmable hardware component can be provided in the input element and/or in the control and processing unit.

It should be noted at this point that the features which have only been mentioned with regard to the input unit or the control and processing unit can also be claimed for the mentioned method and/or the for mentioned non-volatile memory and vice versa.

Furthermore, it is to be noted here that features, e.g. with regard to an evaluation of data and/or signals of the aforementioned sensors and which have only been mentioned with regard to the control and processing unit, can also be claimed for the input element and vice versa.

The invention is hereinafter explained by way of the attached figures. In the figures are shown in:

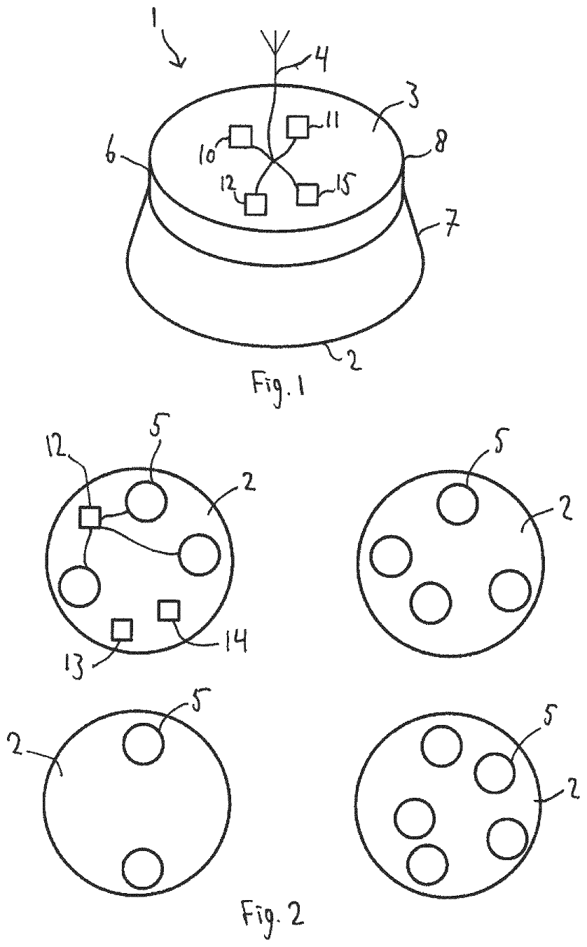

FIG. 1 a perspective view of an input element,

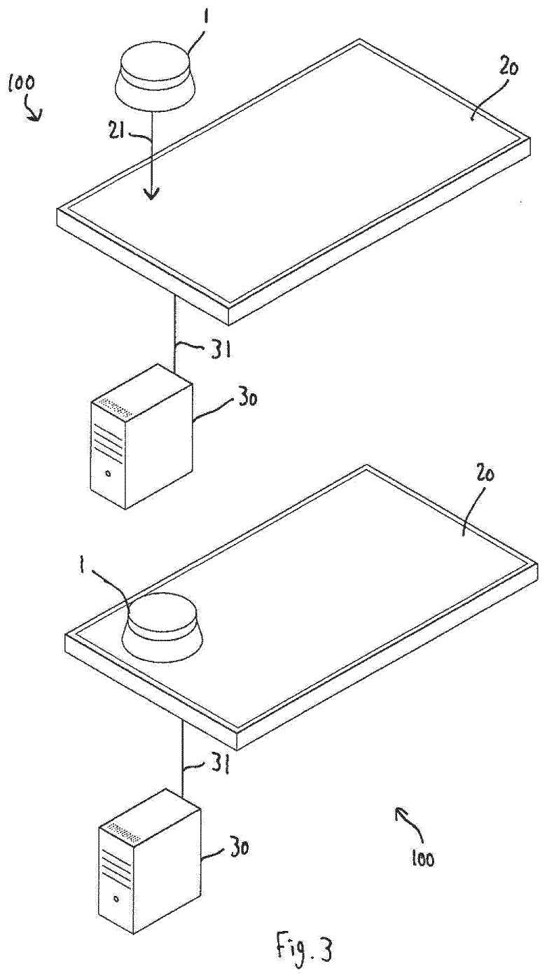

FIG. 2 four views of a lower side of an input element;

FIG. 3 a perspective view of a system which comprises an input element, a touch-sensitive screen as well as a control and processing unit;

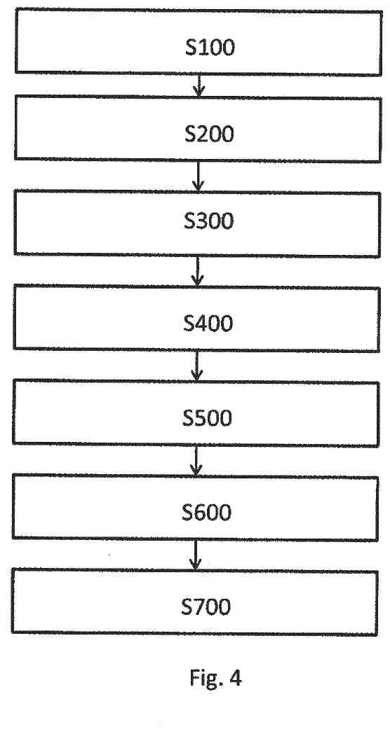

FIG. 4 a block diagram of a method according to one embodiment of the invention

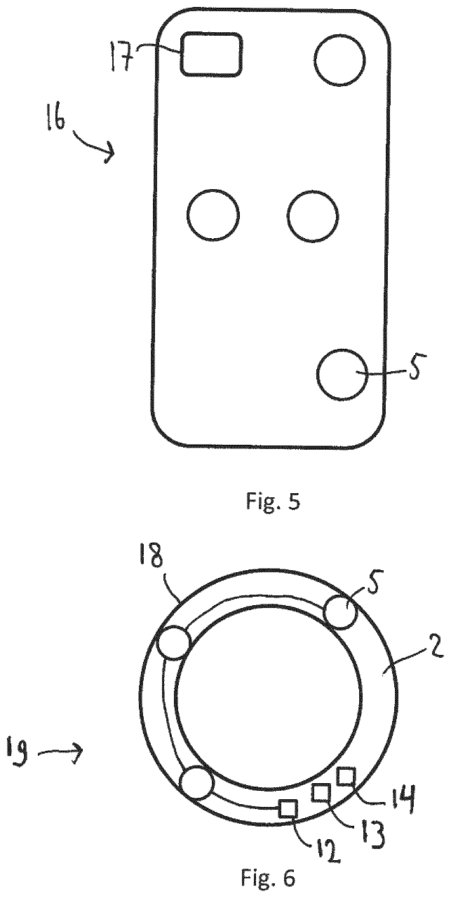

FIG. 5 a lower view of a cover of an input element: and

FIG. 6 a view of a lower side of an annular input element; and

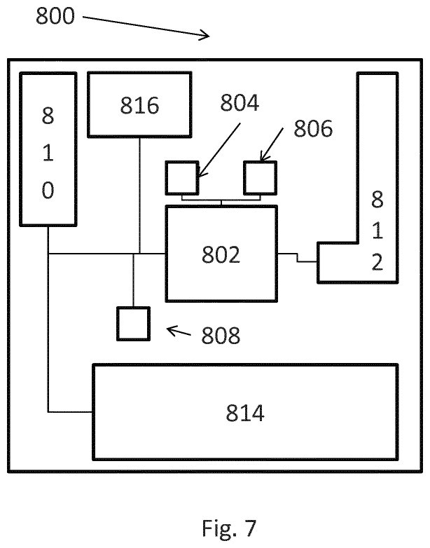

FIG. 7 a schematic arrangement of electronic components on a circuit board.

In the figures, recurring features are provided with the same reference numerals

FIG. 1 shows a perspective view of an input element 1. The input element 1 is designed as an input element 1 for a touch-sensitive screen 20. The input element 1 comprises a housing 8 which comprises a cylinder-shaped attachment 6 as well as a conical part 7 which tapers upwards and consists essentially of a non-conductive rubber. The housing 8 has a lower side 2 and an upper side 3. The input element 1 has a battery for the supply of electricity. The attachment 6 is designed as an aluminium ring and has a distance of at least 2 mm to the lower side 2 of the housing 8. The attachment 6 can be provided with an insulating varnish of about 0.1 mm.

The input element 1 further comprises a communication unit with an antenna 4 for communicating with a control and processing unit 30 which is described further below. On the lower side, the input element 1 comprises a multitude of touch surfaces 5 which are detectable by the touch-sensitive screen 20.

Four exemplary embodiments of lower sides 2 of the input element 1, which is represented in FIG. 1, are shown in FIG. 2. The four different embodiments of the lower side 2 of the input element 1 differ only in the number and arrangement of the touch surfaces 5. Input elements 1 with two touch surfaces 5, with three touch surfaces 5, with four touch surfaces 5 and with five touch surfaces 5 are shown in FIG. 2. The touch surfaces 5 of each input element 1 each form a touch pattern on the lower side 2 of the input element 1, wherein the touch pattern in the embodiments of the input element 1 with three, four or five touch surfaces 5 have no symmetry or a Cₛ-symmetry, i.e. the two-dimensional touch pattern has no rotational symmetry.

In the shown embodiment examples, the touch surfaces 5 are designed to be circular; alternatively, the touch surfaces 5 can also be designed to be oval or elliptical. It is likewise conceivable for the touch surfaces 5 of each individual input element to differ in shape. The input element 1 can therefore comprise a round touch surface, an oval touch surface and an elliptical touch surface 5. In the shown embodiment example, the touch surfaces 5 have a diameter of about 12 mm. The centres of gravity of the touch surfaces 5 each have a minimal distance of 24 mm amongst one another. Furthermore, the touch surfaces 5 are manufactured of an electrically conductive rubber. The touch surfaces 5 are electrically conductively connected amongst one another by way of copper strips or copper wires, which are not represented. Given an input element 1 resting on the touch-sensitive screen 20, the copper strips or wires are distanced to the touch-sensitive screen 20, thus the copper strips or copper wires do not contact the touch-sensitive screen 20. Furthermore, the touch surfaces 5 are electrically conductively connected to the cylinder-shaped attachment 6 by way of copper wires, which are not shown.

Furthermore, the input element 1 comprises a (volatile and/or non-volatile) memory 15. An identification code which is assigned to the specific input element 1 is stored in the memory 15. The identification code can be e.g a UUID. If a multitude of input elements 1 lie on the touch-sensitive screen 20, each input element 1 can be unambiguously indentified by the control and processing unit 30 by way of the identification code. Optionally, the input element 1 can comprise a non-represented processor or a microcontroller which evaluates the signals or data of the individual sensors 10, 11, 12, 13, 14.

If several input elements 1 are used simultaneously, then the touch surfaces 5 are preferably designed in the same manner. In particular, the input elements 1 have an equal touch pattern in this case. The identification codes or identification numbers of the respective input elements 1 can then be used for the differentiation of the individual input elements 1.

The input element of FIG. 1 comprises a multitude of different sensors 10 to 14. An acceleration sensor 10, a gyroscope 11, a field sensor 12, a colour sensor 13 and a proximity sensor 14 are shown in the shown embodiment example. Several colour sensors 13, e.g two colour sensors, can also be provided. Although only one input element 1 of FIG. 2 is represented with sensors 13, 13, and 14, the respective other input elements 1 of FIG. 2 can likewise be equipped with these sensors 12, 13, 14. The field sensor 12, the colour sensor or colour sensors 13 and the proximity sensor are arranged on the lower side 2 of the housing 8 of the input element 1, cf. FIG. 2. One or more openings can be provided on the lower side 2 of the housing 8 in order to simplify a measurement of the sensors 12, 13 and 14. As is indicated in FIG. 1, the acceleration sensor 10 and the gyroscope 11 can be arranged further to the top in the housing 8

The mode of operation of the individual sensors 10, 11, 12, 13, 14 is described further below.

FIG. 5 shows a lower view of a cover 16 of a non-represented input element. In this embodiment, the input element further encompasses a smartphone which comprises an acceleration sensor, a camera, a gyroscope, a proximity sensor, a communication unit, an identification code/identification number, a processor for evaluating the mentioned sensors and a memory in which evaluation and processing software is stored.

The cover 16 which is represented in FIG. 5 is manufactured essentially of a soft, elastic material and can be positively or non-positively fastened to the smartphone. In the assembled condition, the cover 16 forms the lower side of the input element. The cover 16 comprises an opening 17, so that the camera and/or the proximity sensor of the smartphone is not blocked by the cover 16. If the cover 16 comprises a transparent material, then the opening 17 can be done away with. In the shown embodiment example, the cover 16 has four touch surfaces 5 which are electrically connected to one another. The characteristics of the touch surfaces 5 can be found on the touch surfaces 5 shown in FIG. 2. The cover can comprise a thin, insulating cover layer of at the most 0.5 mm for a high-quality visual appearance, said cover layer on the one hand covering the touch surfaces 5 and on the other hand ensuring a detection of the touch surfaces 5 on the touch-sensitive screen 20.

FIG. 6 shows a lower view of an input element 19 with an annular housing 18. The input element 1 of FIG. 6 differs from the input elements which are shown in FIGS. 1 and 2 merely in the housing 18 of the input element 19 being annular. An outer diameter of the annular housing 18 can be e.g. at least 90 mm, at least 110 mm, in particular at least 130 mm, particularly preferably at least 150 mm. Although the shown input element 19 comprises three touch surfaces 5, two, four, five or more touch surfaces 5 can also be provided, as is shown in FIG. 2. The touch surfaces 5 preferably have an inner angle of about 63°, 73° and 44°. The housing 18 on an upper side can comprise a conductive material, such as the annular attachment in FIG. 1, said material being electrically conductively connected to the touch surfaces 5 and having a minimum distance of 2 mm to a lower side of the housing 19. Between the lower side 2 and the conductive material, the housing is manufactured of a non-conductive rubber with a Shore hardness of A80.

In further embodiments, the housing of the input element 1 or of the input element 19 can also be designed e.g. in a cuboid manner, as a disc or as a plate, for example with a height of 1 cm.

FIG. 3 shows two perspective views of a system 100, wherein the system comprises the input element 1 which is described in FIGS. 1 and 2 and furthermore a touch-sensitive screen 20 as well as a control and processing unit 30. The touch-sensitive screen 20 is connected to the control and processing unit 30 by way of a cable 31, wherein the cable is preferably designed as a USB cable. The touch-sensitive screen 20 is also identified as a touchscreen and in the shown embodiment example is a capacitive touch-sensitive screen. However, in other embodiment examples, it is also possible to design the touch-sensitive screen 20 as an optical, inductive or resistive touch-sensitive screen. The touch-sensitive screen 20 can also function e.g as a table top, and in this case table legs can be assembled on the touch-sensitive screen 20.

Furthermore, the touch-sensitive screen 20 is designed to simultaneously detect a multitude of touches (multitouch display). The contact can hereby be effected by a human finger as well as by the touch surfaces 5 of the input element 1 shown at the top. Furthermore, touch surfaces 5 of a multitude of input elements 1 can be simultaneously detected by the touch-sensitive screen 20.

The control and processing unit 30 comprises a second communication unit for communicating with the first communication unit 4 of the input element 1. The control and processing unit 30 in particular is designed for receiving and evaluating the signals or data which are detected by the sensors 10 to 14 of the input element 1. Alternatively or additionally, the input element 1 can also be designed to evaluate the data or the signals of the sensors 10 to 14 by way of the aforementioned processor. In this case, the control and processing unit 30 is designed to receive the data of the sensors 10 to 14, said data having been evaluated by the processor of the input unit 1.

The control and processing unit 30 comprises e.g a microcontroller, a processor, a microprocessor and/or a digital signal processor for processing and/or handling and/or evaluating the signals and/or data of the aforementioned sensors 10, 11, 12, 13, 14.

The control and processing unit 30 is moreover designed for receiving and evaluating signals (touch signals) which are triggered in the touch-sensitive screen 20 by the touch surfaces 5 of the input element 1. Furthermore, the control and processing unit 30 is designed to compare touch signals which are measured by the touch-sensitive screen 20 with the signals or data of the sensors 10 or 14 and by way of the comparison to determine a position, a position change, a rotation angle and a rotation angle change of the input element 1 on the touch-sensitive screen 20.

The control and processing unit 30 can activate the touch-sensitive screen 20 or another non-shown device or carry out a certain action, depending on the position and/or the rotation angle and/or the position change and/or the rotation angle change of the input element 1.

The effect of the individual sensors 10 to 14 is described hereinafter.

The acceleration sensor 10 is designed for detecting a putting-down of the input element 1 onto the touch-sensitive screen 20. The putting-down movement of the input element 1 is indicated in FIG. 3 by way of the arrow 21. Upon setting down, a characteristic brief acceleration occurs in the direction of the upper side 3 of the input element 1. This characteristic acceleration upon placing down can be recognised by way of evaluating the acceleration and one can then ascertain that the input element 1 was placed onto touch-sensitive screen 20. The touch-sensitive screen 20 subsequently detects that the touch surfaces 5 of the input element 1 have been placed on the screen 20.

The identification code UUID which is specific to the respective input element is transferred to the second communication unit of the control and processing unit 30 via the first communication unit 4. The signals of the acceleration sensor 10 and a roughly simultaneous appearance of the touch surfaces 5 on the touch-sensitive screen 20 as well as the identification code of the input element 1 which is transmitted via radio connection permit an unambiguous identification of the input element 1.

Furthermore, one can therefore unequivocally recognise a position and/or orientation of the input element 1 on the touch-sensitive screen 20 on the basis of the signals of the acceleration sensor 10 and of the signals which are triggered in the touch-sensitive screen 20 by the touch surfaces 5 of the input element 1.

The acceleration sensor 10 is further designed to detect an acceleration of the input element 1 on the touch-sensitive screen 20. As is described further above, it can occur that the touch-sensitive screen 20 filters out one or more touch surfaces 5 of the input element 1, since they have been recognised as errors. A direction change of the input element 1 can be changed and/or predicted by the detection of the acceleration of the input element 1 on the touch-sensitive screen 20, and the touch surfaces 5 can again be assigned to the respective input element 1 by way of the linking of the data of the acceleration sensor 10 with the signals which are triggered in the touch-sensitive screen by the touch surfaces 5 of the input element 1.

Furthermore, the acceleration sensor 10 can be designed for detecting a picking-up of the input element 1 from the touch-sensitive screen 20. Specifically, a characteristic brief acceleration in the direction of the upper side 2 of the input element 1 also occurs on picking up. One can therefore recognise that the input element 1 is no longer located on the touch-sensitive screen 20 by way of evaluating this signal.

In an embodiment, the input element 1 is designed to create a connection to the control and processing unit 30 if an acceleration which is different to gravitational acceleration is ascertained by the acceleration sensor.

Typically, the acceleration sensor 10 is designed for detecting an acceleration with a temporal accuracy of at least 10 milliseconds. Accelerations should therefore be able to be differentiated from one another if they are effected in a temporal interval of 10 milliseconds or more. In this case, one can reliably recognise if two input elements 1 have been quasi simultaneously put down onto the touch-sensitive screen 20. Here. “quasi simultaneously” therefore means that the putting-down of the two input elements has a temporal difference of at the most 10 ms or at the most 20 ms or at the most 50 ms.

A speed reduction or a speed increase of the input element 1 in different directions can therefore be detected with the help of the acceleration sensor 10. The direction in which the input element 1 is accelerated is also detected by the acceleration sensor 10 by way of it determining from where the gravity acts upon the input element 1. During this, a displacement of the forces as a rule is measured along three axes, the x-axis (left/right), the y-axis (upwards/downwards) and the z-axis (to the front and rear). The acceleration sensor 10 uses a micro-electromechanical system for this (MEMS). Three silicon rods, which are a few micrometres wide and act as springs, are located in the middle of the acceleration sensor 10 usually measuring about 3×3 mm. If the input element 1 is moved or rotated, then the three rods move due to the inertia of their intrinsic mass and a position changes vis-à-vis electrodes which are fixed at the edge. Software then computes a magnitude of the acceleration from the changing electrical capacitance. Other embodiments of the acceleration sensor which are known to the person skilled in the art are also possible.

The gyroscope 11 measures a rotational speed and thereby rotation movements of the input element 1. The movement change of the input element 1 can therefore be recognised together with the acceleration sensor 10. The gyrocope 11 can be calibrated after placing the input element on the touch-sensitive screen 20. As has already been indicated above, the control and processing unit 30 is designed to evaluate and/or receive signals which are activated in the touch-sensitive screen by way of the touch surfaces of the input element. An orientation of the touch surfaces 5 on the touch-sensitive screen 20 can be determined by way of this evaluation. The gyroscope 11 can be calibrated with the help of such determining of the orientation of the touch surfaces 5 and therefore of the input element 1. In particular, the control and processing unit 30 can be designed to evaluate signals of the gyroscope 11 of the input element and to determine a rotation angle of the input element 1 on the basis of measured signals of the gyroscope 11.

The field sensor 12 measures an electrical field strength in each of the touch surfaces 5. The field sensor 12 comprises an antenna, a signal amplifier and an analog-to-digital converter which converts the electrical field strength into digital values. Here, the touch surfaces 5 serve as antennae for the field sensor 12. The field sensor 12 detects the field strength, for example with a measuring frequency of approx. 400 kHz. A variance of the signal above approx. 400 values is subsequently computed. Values which differ from this are likewise possible.

Hereinafter, n is the number of values and fₙ the nth value of the field strength. The middle value p and variance v are then computed according to the common formulae:

$$μ = \frac{1}{n} {\sum }_{i = 1}^{n} {f}_{n}$$

$$v = \frac{1}{n} {\sum }_{i = 1}^{n} {( x - μ )}^{2}$$

Specifically, e.g. for determining a variance value, n=4096. Herein, the variance can be determined every 4096 points. The field strength is measured with a frequency of 400 kHz (every 0.0025 ms). Values of the variance are obtained at a frequency of 100 Hz (every 10 ms) by way of this. A running window for determining the variance is alternatively for example 4096 points.

An electrical field strength of the touch-sensitive screen 20 and/or a change of the electrical field strength is measured by the field sensor 12. For example, the following relative values are measured for the variance of the electrical field strength: above 1000 on the touch-sensitive screen 20; roughly 100 given a distance of 1 mm to about 5 mm between the input element 1 and the screen 20; and 0 given a distance of 10 mm or more between the input element 1 and the screen 20.

One can recognise whether the input element is located on the touch-sensitive screen 20 or not without any calibration to a special touch-sensitive screen 20 due to the measurement of the variance of the electrical field strength.

The colour sensor 13 is arranged on the lower side 2 of the input element 1. The colour sensor 13 is designed as a camera in the shown embodiment example. One can detect which colour is presently displayed on the touch-sensitive screen 20 below the colour sensor 13 by way of the colour sensor 13. For example, a certain colour pattern can be displayed at least briefly on the touch-sensitive screen 20. One can ascertain where the input element 1 is located on the touch-sensitive screen 20 by way of the comparison of the data which is obtained by the colour sensor 13 with a colour signal which is outputted by the touch-sensitive screen 20. Furthermore, a rotation angle or orientation of the input element 1 on the touch-sensitive screen 20 can be determined by way of this. If several input elements 1 are placed simultaneously onto the touch-sensitive screen 20, then one can unambiguously determine an identity of the input elements 1 on the basis of the colour and/or brightness comparison. Furthermore, a position change of the input element 1 can be measured with the help of the colour sensor 13.

The proximity sensor 14 is likewise arranged on the lower side 2 of the input element 1. With the proximity sensor 14, one can likewise recognise whether and when the input element 1 was placed upon the touch-sensitive screen 20. For this, the proximity sensor 14 uses an infrared beam in order to examine whether the input element 1 is approaching the touch-sensitive screen 20.

Should a sensor 10, 11, 12, 13, 14 deliver inadequate information on a current position and/or on a current rotation angle of the input element 1, or not all touch surfaces be recognised by the touch-sensitive screen, then this information can be completed by way of using the data of the other sensors.

It is clear to the person skilled in the art that signals or data of each of the individual sensors 10, 11, 12, 13, 14 can be evaluated by way of e.g measured signals or data being compared with predefined reference values or predefined threshold values. The signals of the respective sensors 10, 11, 12, 13, 14 can also be compared with previously measured signals. Under certain circumstances, the predefined reference values or the predefined threshold values can also be adaptively regulated.

Furthermore, a method for recognising the previously described input element 1 on the previously described touch-sensitive screen 20 is suggested with the invention. Individual steps of the method are specified in FIG. 4.

The method comprises the following steps:
building up a radio connection between the first communication unit of the input element 1 and the second communication unit of the control and processing unit 2 (S100);
determining an identity of the input element 1 by way of transferring the identification code which is stored in the memory 15 of the input unit 1 to the control and processing unit 30;
detecting an acceleration of the input element 1 by way of an acceleration sensor 10 (S200);
transferring the sensor signals of the acceleration sensor 10 to the control and processing unit 2 (S300);
evaluating the signals which are detected by the acceleration sensor 10 (S400);
receiving and evaluating signals (touch signals) which are triggered in the touch sensitive screen 20 by the touch surfaces 5 of the input element 1, by the control and evaluation unit (S500);
comparing the touch signals with the evaluated signals of the acceleration sensor 10 (S600);
determining a position, a position change, a rotation angle and/or a rotation angle change of the input element 1 on the touch-sensitive screen 20 by way of the comparison of the touch signals with the evaluated signals of the acceleration sensor 10 (S700).

Step S500 can also be effected before S200 depending on the speed of the radio connection in relation to the speed of the recognition of the touch-sensitive screen 20.

As an alternative or additionally to the method described above, the following steps can also be carried out:
detecting an acceleration of the input element 1 by way of an acceleration sensor 10;
evaluating the signal of the acceleration sensor 10 by a processor of the input element 1;
recognising an acceleration of the input element 1 which is different to the acceleration of gravity;
establishing a radio connection between the first communication unit of the input unit 1 and the second communication unit of the control and processing unit 30;
determining an identity of the input element 1 by way of transferring the identification code, which is stored in the memory 15 of the input unit 1, to the control and processing unit 30;
using the control and processing unit 30 to receive and evaluate signals (touch signals) which are triggered in the touch-sensitive screen 20 by the touch surfaces 5 of the input element 1;
comparing the touch signals with the evaluated signals of the acceleration sensor 10;
determining a position, a position change, a rotation angle and/or a rotation angle change of the input element 1 on the touch-sensitive screen 20 by way of the comparison of the touch signals with the evaluated signals of the acceleration sensor 10.

The two mentioned methods can comprise the following steps aspects:
detecting sensor signals by the gyroscope 11, the field sensor 12, the colour sensor 13 or colour sensors and the proximity sensor 14;
transferring the sensor signals of the gyroscope 11, of the field sensor 12, of the colour sensor 13 or of the colour sensors or of the proximity sensor 14 to the control and processing unit 30;
evaluating the sensor signals which are detected by the sensors 11-14, by the control and processing unit 30;
receiving and evaluating signals (touch signals) which are triggered in the touch-sensitive screen 20 by the touch surfaces 5 of the input element 1, by way of the control and processing unit 30;
comparing the touch signals with the evaluated sensor signals of the sensors 11-14;
determining a position, a position change, a rotation angle and/or a rotation angle change of the input element 1 on the touch-sensitive screen 20 by way of the comparison of the touch signals with the evaluated sensor signals of the sensors 11-14.

The mentioned method can comprise further following steps:
recognising a putting-down of the input element 1 onto the touch-sensitive screen 20 on the basis of the measured acceleration and/or of the measured field strength and/or of a colour pattern which is displayed by the touch-sensitive screen 20 and measured by the colour sensor and/or of the distance between the input element 1 and the touch-sensitive screen 20;
a lifting of the input element 1 from the touch-sensitive screen 20.

The method can further comprise the following steps:
recognising a position and/or orientation of the input element on the touch-sensitive screen if it is simultaneously detected by the touch-sensitive screen 20 as well as by the acceleration sensor 10 and/or the further sensors 11-14 that the input element 1 is put down onto the touch-sensitive screen 20 and/or the input element 1 is located on the touch-sensitive screen 20.

The simultaneous detection hereby includes a temporal difference of at the most 50 ms or at the most 30 ms or at the most 20 ms between the detections.

The control and processing unit 30 subsequently controls the touch-sensitive screen 20 or another device or carries out a certain action, depending on a position and/or a rotation angle and/or a position change and/or a rotational angle change of the input element 1.

The invention further comprises a computer program which is designed to carry out the aforementioned method. The computer program can be stored in a memory of the input element or in the memory of the control and processing unit 30.

Features which have only been mentioned in the context of the method can be combined with features which have only been mentioned in the context of the input element 1 and/or the touch-sensitive screen 20 and/or the control and processing unit 30 and vice versa.

One possible arrangement of electronic circuit elements of the input element is explained by way of FIG. 7. A multitude of electronic components are arranged on a circuit board 800 which is designed as a printed circuit board (PCB), on the illustrated front side.

A CPU 802 which realises the evaluation of the sensors is arranged on the front side. The sensors hereby comprise one (or more) gyroscopes 804, an acceleration sensor 806, a field sensor with suitable electronics 808 as well as colour sensors, which are arranged on the rear side of the circuit board which is not shown.

The circuit board further comprises an electricity supply and battery charging electronics 810 which amongst other things ensures the electricity supply of the individual electronic components by way of a battery 812.

A Bluetooth antenna 814 with corresponding signal adaptations electronics is provided in order to transfer the pre-processed signals to an evaluation unit, said signal adaption electronics being responded to via the CPU 802. Furthermore, an adapter 816, via which the circuit arrangement can be played with updated firmware, is provided.

1. An input element for a touch-sensitive screen, the input element comprising:
a first communication unit for communicating with a control and processing unit;
at least two touch surfaces which are detectable by the touch-sensitive screen; and
an acceleration sensor for detecting an acceleration of the input element.

2. The input element according to claim 1, wherein the acceleration sensor is configured for detecting at least one of:
a putting-down of the input element onto the touch-sensitive screen and/or
an acceleration of the input element on the touch-sensitive screen and/or
a lifting of the input element from the touch-sensitive screen.

3. The input element according to claim 2, configured to
create a connection to the control and processing unit by way of the first communication unit
when an acceleration of the input element which is different to the gravitational acceleration has been detected by the acceleration sensor.

4. The input element according to claim 1, wherein the acceleration sensor is configured for detecting an acceleration with an accuracy of at least 0.2 g and/or a transmission rate of at least 10 Hz.

5. The input element according to claim 1, comprising at least one of
a gyroscope (11) for detecting a rotation movement of the input element; and/or
a field sensor for detecting an electrical field strength of the touch-sensitive screen and/or for measuring a change of the electric field strength of the touch-sensitive screen; and/or
a color sensor or several color sensors for detecting color in at least one region of the touch-sensitive screen, said color being displayed by the touch-sensitive screen; and/or
a proximity sensor (14) for detecting a distance between the touch-sensitive screen and the input element.

6. The input element according to claim 5, wherein the field sensor is configured for detecting an electrical field strength in at least one of the touch surfaces.

7. A multitude of the input elements according to claim 1, wherein the touch surfaces of each input element form a pattern and each input element has an identical pattern, wherein each input element comprises a memory, in which an identification code or an identification number is stored, said code or number being assigned to the respective input element.

8. A control and processing unit, configured for communication with an input element for a touch-sensitive screen, the input element comprising a first communication unit for communicating with the control and processing unit, at least two touch surfaces that are detectable by the touch-sensitive screen, and an acceleration sensor for detecting an acceleration of the input element, the control and processing unit comprising:
a second communication unit for communicating with the input element or a multitude of input elements,
wherein the control and processing unit is connected to a touch-sensitive screen and is configured for receiving and/or evaluating one or more signals which are triggered in the touch-sensitive screen by the touch surfaces of the input element.

9. The control and processing unit according to claim 8, configured for
evaluating and/or receiving a signal which is detected by the acceleration sensor of the input element; and
recognising, on the basis of the signal of the acceleration sensor, at least one of
a putting-down of the input element onto the touch-sensitive screen and/or
a movement direction and/or a resting of the input element on the touch-sensitive screen and/or
a picking-up of the input element from the touch-sensitive screen.

10. The control and processing unit according to claim 8, configured for
recognising a position and/or an orientation of the input element on the touch-sensitive screen on the basis of the signal of the acceleration sensor and of one or more of the signals which are triggered in the touch-sensitive screen by the touch surfaces of the input element.

11. The control and processing unit according to claim 8, configured for
determining a variance of the electrical field strength which is temporally measured by the field sensor of the input element,
comparing the determined variance of the electrical field with a predefined value, and
when the determined variance is larger than the predefined value, detecting that the input element is arranged on the touch-sensitive screen.

12. The control and processing unit according to claim 8, configured for evaluating one or more signals of a gyroscope of the input element and to determine a rotation angle of the input element on the basis of one or more of the measured gyroscope signals.

13. The control and processing unit according to claim 12, configured for
evaluating and/or receiving one or more signals which are triggered in the touch-sensitive screen by the touch surfaces of the input element;
determining an orientation of the touch surfaces on the touch-sensitive screen on the basis of the one or more signals which are triggered in the touch-sensitive screen by the touch surfaces of the input element; and
calibrating the gyroscope (11) for determining an absolute rotation angle of the input element with respect to a fixed coordinate system of the touch-sensitive screen.

14. The control and processing unit according to claim 8, configured for
receiving and/or evaluating the signals which are measured by a color sensor or color sensors;
comparing the signal with a color signal of the touch-sensitive screen; and
determining a position and/or a rotation angle of the input element on the basis of the comparison.

15. The control and processing unit according to claim 8, configured to activate the touch-sensitive screen or to carry out a certain action, depending on a position and/or a rotation angle and/or a position change and/or a rotation angle change of the input element.

16. A method for recognising an input element on a touch-sensitive screen, wherein the input element comprises at least two touch surfaces which are detectable by the touch-sensitive screen, the method comprising the steps of:
detecting an acceleration of the input element by way of an acceleration sensor;
evaluating a signal which is detected by the acceleration sensor;
recognising, on the basis of a measured acceleration, at least one of
a putting-down of the input element onto the touch-sensitive screen and/or
a movement direction and/or a resting of the input element on the touch-sensitive screen and/or
a picking-up of the input element from the touch-sensitive screen.

17. A non-volatile memory which is readable by a computer, comprising a computer program which, when it is runs on a programmable hardware component, is configured to
evaluate a signal which is detected by an acceleration sensor of an input element for a touch-sensitive screen, the input element comprising a first communication unit for communicating with the control and processing unit, at least two touch surfaces that are detectable by the touch-sensitive screen, and an acceleration sensor for detecting an acceleration of the input element; and
recognise, on basis of the measured acceleration, at least one of
a putting-down of the input element onto the touch-sensitive screen and/or
a movement direction and/or a resting of the input element on the touch-sensitive screen and/or
a picking-up of the input element from the touch-sensitive screen.
